(19) United States
(12) Patent Application Publication
(10) Pub. No.: US 2024/0281812 A1
(43) Pub. Date: Aug. 22, 2024

(54) CROSS-ENTITY TRANSACTION ANALYSIS

(71) Applicant: Wells Fargo Bank, N.A., San Francisco, CA (US)

(72) Inventors: Kristine Ing Kushner, Orinda, CA (US); John T. Wright, Benicia, CA (US)

(21) Appl. No.: 17/344,653

(22) Filed: Jun. 10, 2021

(51) Int. Cl. G06Q 20/40; G06Q 20/38; G06Q 40/02

(52) U.S. Cl. CPC G06Q 20/4016; G06Q 20/389; G06Q 40/02

(57) ABSTRACT

This disclosure describes techniques for performing cross-institution analysis of data, including analysis of transaction data occurring across multiple financial institutions. In one example, this disclosure describes a method that includes receiving a first set of transaction data associated with accounts at the first entity; receiving a second set of transaction data associated with accounts at the second entity; identifying transaction data associated with an account holder having a first account at the first entity and a second account at the second entity, wherein the transaction data associated with the account holder includes information about transactions occurring on the first account and information about transactions occurring on the second account; assessing a likelihood of fraud having occurred on at least one of the first account or the second account; and performing an action.

### TECHNICAL FIELD

This disclosure relates to computer networks, and more specifically, to fraud identification and/or mitigation.

### BACKGROUND

Financial institutions often maintain multiple accounts for each of their customers. For example, a given banking customer may hold a checking, savings, credit card, loan account, mortgage, and brokerage account at the same bank. Typically, financial institutions monitor transactions being performed by their customers to determine whether erroneous, fraudulent, illegal, or other improper transactions are taking place on accounts they maintain. If such transactions are detected, the financial institution may take appropriate action, which may include limiting use of the affected account(s).

Banking services consumers may have relationships with multiple banks or financial institutions. Accordingly, consumers may have multiple accounts across multiple financial institutions.

### SUMMARY

This disclosure describes techniques for performing cross-institution analysis of data, including analysis of transaction data occurring across multiple financial institutions. In some examples, each of several financial institutions may send abstracted versions of underlying transaction data to a cross-entity computing system that is operated by or under the control of an organization that is separate from or otherwise independent of the financial institutions. The cross-entity computing system may analyze the data to make assessments about the data, including assessments about whether fraud is, or may be, occurring on accounts maintained by one or more of the financial institutions.

Although each such financial institution may perform its own analytics to detect fraud, the cross-entity computing system may be in a better position to make at least some assessments about the data. Generally, if the cross-entity computing system receives data from each of the financial institutions, the cross-entity computing system may be able to identify fraud that might not be apparent based on the data available to each of the financial institutions individually.

In some examples, this disclosure describes operations performed by a collection of computing systems in accordance with one or more aspects of this disclosure. In one specific example, this disclosure describes a system comprising a first entity computing system, controlled by a first entity, configured to convert transaction data associated with a first account held by an account holder at the first entity into a first set of abstracted transaction data and output the first set of abstracted transaction data over a network; a second entity computing system, controlled by a second entity, configured to convert transaction data associated with a second account held by the account holder at the second entity into a second set of abstracted transaction data and output the second set of abstracted transaction data over the network; and a cross-entity computing system configured to: receive, from the first entity computing system, the first set of abstracted transaction data, receive, from the second entity computing system, the second set of abstracted transaction data, determine, based on the first set of abstracted transaction data and the second set of abstracted transaction data, that the first set of abstracted transaction data and the second set of abstracted transaction data correspond to transactions performed by the account holder, assess, based on the first set of abstracted transaction data and the second set of abstracted transaction data, a likelihood of fraud having occurred on at least one of the first account or the second account, and perform, based on the assessed likelihood of fraud, an action.

In another example, this disclosure describes a method comprising operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A and FIG. 1B are conceptual diagrams illustrating a system in which multiple entities provide data to an organization to enable cross-entity analysis of such data, in accordance with one or more aspects of the present disclosure.

FIG. 2 is a conceptual diagram illustrating examples of transaction data, abstracted transaction data, and cross-entity data, in accordance with one or more aspects of the present disclosure.

FIG. 3 is a block diagram illustrating an example system in which multiple entities provide data to an organization to enable cross-entity analysis of such data, in accordance with one or more aspects of the present disclosure.

FIG. 4 is a flow diagram illustrating an example process for performing cross-entity fraud analysis in accordance with one or more aspects of the present disclosure.

### DETAILED DESCRIPTION

This disclosure describes aspects of a system operated by a cross-business and/or cross-institution fraud detection organization that may work in cooperation with multiple member businesses and/or member institutions. In some examples, such member institutions may be financial institutions or similar entities. The cross-entity fraud detection organization (“cross-entity organization” or “organization”) may operate or control a computing system that is configured to identify and escalate potential fraud to member businesses and/or member institutions. As described herein, such a system may be effective in scenarios where the fraud might not be apparent based on activities or transactions occurring at a single financial institution.

For example, suppose credit cards issued by different banks are stolen and sold to different individuals that intend to commit fraud. One individual uses one credit card in New York, while the other individual uses a different credit card in California. Each transaction might appear somewhat unusual to each issuing bank, but from the perspective of each bank, often neither transaction will be viewed as unusual enough to prompt fraud mitigation actions by either bank. However, if a cross-entity organization has a view of both transactions, fraud could be detected and potentially prevented, since an overall increased transaction velocity (i.e., a spend increase over a given period of time) and a geographic discrepancy for transactions using the credit cards will be apparent. The cross-entity organization could itself act to mitigate fraud, or in some examples, the organization might notify each of the banks issuing the credit cards, or in addition, notify the account holder. In some cases, the issuing banks may act to limit further credit card use.

In examples described herein, each member institution shares some aspects of their data with the cross-entity organization, and in addition, such member institutions may subscribe to (i.e., receive) data distributed by the organization. Receiving subscription data may conditioned upon each of the institutions sharing privacy-treated, abstracted, and/or high-level transaction information derived from transactions performed on their own customers' accounts. Each customer holding an account at any financial institution may be assigned (e.g., by the cross-entity organization) a federated identification code (“federated ID”) that may be used across all of the member institutions where each such customer has accounts. The federated ID might associate cross-entity transactions with a specific person, but might not identify the person or reveal any other information about the person. The cross-entity organization may use the federated ID to track activity on customers' accounts across all of the member institutions to, for example, identify potential fraud that might not be apparent just based on activity on the customer's account at one of the institutions.

In some examples, the organization may operate within a single institution, e.g., a single bank, to identify fraud and escalate fraud notifications to multiple member businesses within the institution. However, financial institutions normally avoid sharing data with other competitor financial institutions. Similarly, customers of such financial institutions normally prefer to avoid, at least for privacy reasons, sharing of their own data, particularly across multiple financial institutions. Therefore, in examples herein, the cross-entity organization is primarily described as an external, independent entity relative to each member institution. Such an organization may have policies in place to ensure that sharing of data from multiple financial institutions is done without enabling customer or competitive information from one financial institution to be shared with another. Similarly, such an organization may have policies in place to protect the privacy of customers of each financial institution (e.g., policies mandating that the organization store little or no financial data or transaction data).

Accordingly, throughout the disclosure, examples may be described where a computing device and/or a computing system analyzes information (e.g., transactions, wire transfers, interactions with merchants and/or businesses) associated with a computing device and a user of a computing device, only if the computing device receives permission from the user of the computing device (“customer,” “consumer,” or “account holder”) to analyze the information. For example, in situations described or discussed in this disclosure, before one or more server, client, user device, mobile phone, mobile device, or other computing device or system may collect or make use of information associated with a user, the user may be provided with an opportunity to provide input to control whether programs or features of any such computing device or system can collect and make use of user information (e.g., fraud monitoring and/or detection, interest profiles, search information, survey information, information about a user's current location, current movements and/or speed, etc.), or to dictate whether and/or how to the information collected by the device and/or system may be used. In addition, certain data may be treated in one or more ways before it is stored or used by any computing device, so that personally-identifiable information is removed. For example, a user's identity may be treated so that no personally identifiable information can be determined about the user, or a user's geographic location may be generalized where location information is obtained (such as to a city, ZIP code, or state level), so that a specific location of a user cannot be determined. Thus, the user may have control over how information is collected about the user and used by all computing devices and/or systems.

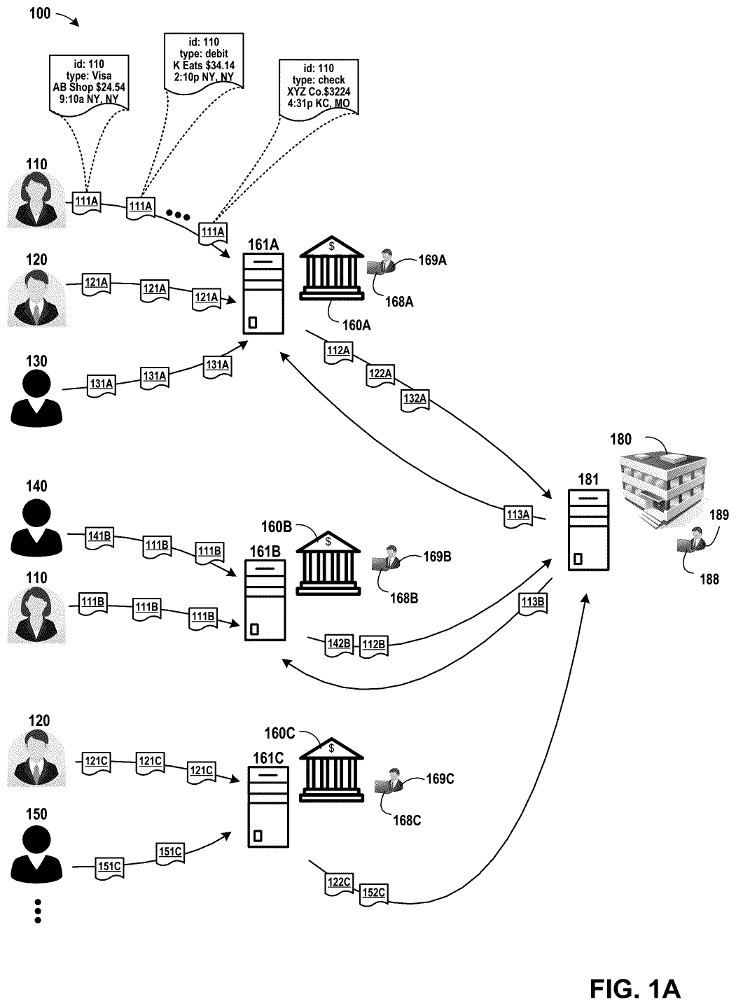

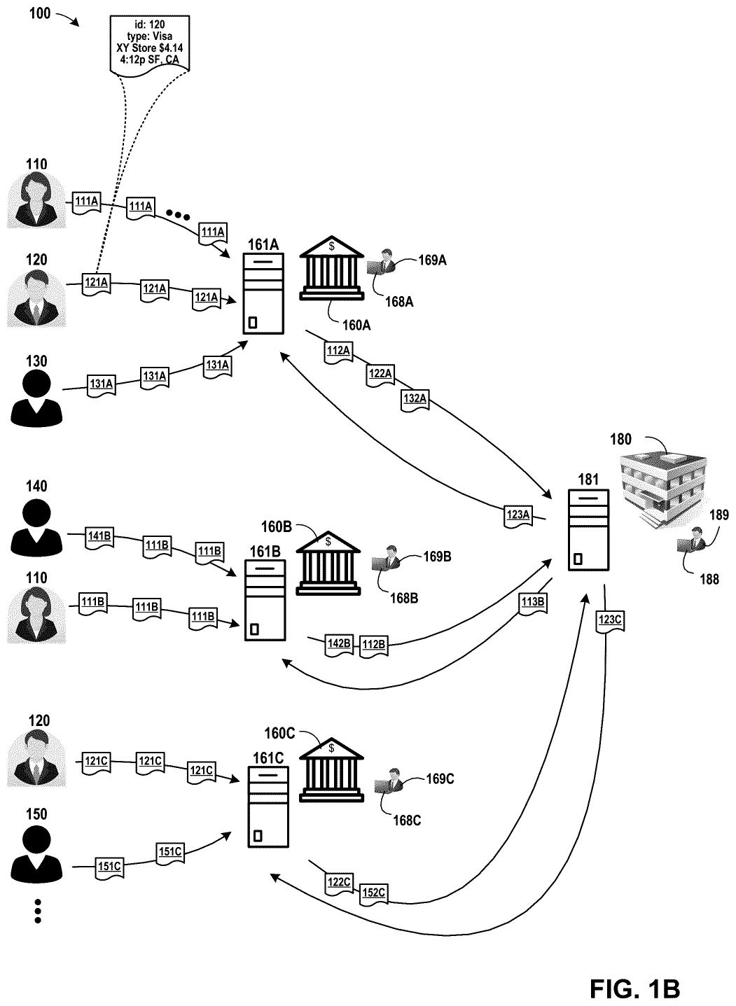

FIG. 1A and FIG. 1B are conceptual diagrams illustrating a system in which multiple entities provide data to an organization to enable cross-entity analysis of such data, in accordance with one or more aspects of the present disclosure. System 100 of FIG. 1A and FIG. 1B illustrates entities 160A, 160B, and 160C (collectively “entities 160”) each sharing data with organization 180. As described herein, organization 180 may receive data from each of entities 160, analyze and/or process the data, and perform cross-entity analysis of the data. Such an analysis may provide insights into the data that might not otherwise be apparent to each individual entity 160, where each such individual entity 160 considers only its own data.

Although techniques described herein may apply to many types of data and business entities, each of entities 160 is primarily described herein as a separately or independently-operated financial institution or bank. In such examples, organization 180 may be an association of multiple financial institutions or a consortium of entities 160 that seek to share some aspects of their data and/or their customers' data to better evaluate, assess, and analyze activities of each of their respective clients and/or account holders. The data shared by each of entities 160 with organization 180 may pertain to financial account usage information, transactions data, and/or other financial activity data. In some examples, organization 180 may be organized as a joint venture or partnership of various entities (e.g., entities 160). Organization 180 could be organized as a non-profit organization. In other examples, organization 180 may be a private, for-profit independent entity that none of entities 160 directly or indirectly control. Although organization 180 may itself be one of entities 160 (i.e., in the sense that organization 180 is a bank or financial institution or otherwise in the same line of business as other entities 160), organization 180 is preferably independent of each of entities 160 to enable more effective treatment of privacy issues, competitive issues, and other issues.

In FIG. 1A and FIG. 1B, each of entities 160 has a number of clients, customers, or account holders that maintain one or more accounts with that entity. In the example shown in FIG. 1A, entity 160A has three clients and/or customers (customers 110, 120, and 130). Entity 160B has two clients and/or customers (customers 140 and 110). Entity 160C has two clients and/or customers (customers 120 and 150).

Individuals designated by reference numerals 110, 120, 130, 140, and 150 in FIG. 1A and FIG. 1B are primarily described herein as “customers.” However, techniques described herein may apply in other contexts in which activity or other actions of similarly-situated individuals might be shared, evaluated, and/or analyzed. In some of those situations, such individuals might not be strictly considered “customers” of any of entities 160 or any other entity. However, techniques described herein are intended to apply to such situations, even for situations in which activity of customers 110, 120, 130, 140, and 150 might not be strictly considered “customers.”

In many cases, customers of one bank or entity 160 may hold multiple accounts at that entity 160. For example, customer 110 may hold one or more credit card accounts, checking accounts, loan or mortgage accounts, brokerage accounts, or other accounts at entity 160A. In addition, customer 110 may hold accounts at different entities 160. For instance, in the example illustrated in FIG. 1A, customer 110 has accounts at both entity 160A and entity 160B (i.e., customer 110 shown adjacent to entity 160A is the same person as customer 110 shown adjacent to entity 160B). Accordingly, in the example illustrated in FIG. 1A, customer 110 may have a credit account associated with a credit card issued by entity 160A, and customer 110 may also hold a credit account associated with a credit card issued by entity 160B. Generally, entity 160A will not know whether customer 110 holds other accounts at other entities 160, or at least will not likely be aware of all the details of accounts that customer 110 holds at different financial institutions. In addition, entity 160A will not likely be aware of the details of any transactions performed by customer 110 using accounts held by customer 110 at other institutions (e.g., entity 160B). Similarly, entity 160B will not likely be aware of the details of any transactions performed by customer 110 using accounts held by customer 110 at entity 160A.

As can be seen from FIG. 1A, customer 120 has accounts at both entity 160A and entity 160C (each illustration of customer 120 in FIG. 1A is intended to represent the same person). And in a manner similar to that described with respect to customer 110, neither entity 160A nor entity 160C is likely to have any details about accounts and activities performed by customer 120 at other entities 160.

Each of entities 160 owns, operates, and/or controls various computing systems. Specifically, entity 160A owns, operates, and/or controls computing system 161A, entity 160B owns, operates, and/or controls computing system 161B, and entity 160C owns, operates, and/or controls computing system 161C. Each such computing system 161 may be used by a respective entity 160 for processing, analyzing, and administering transactions performed by account holders that entity. Although computing systems 161A, 161B, and 161C are shown as a single system, such systems are intended to represent any appropriate computing system or collection of computing systems that may be employed by each of entities 160. Such computing systems may include a distributed, cloud-based data center or any other appropriate arrangement.

Each of entities 160 may also have one or more analyst computing systems 168, each potentially operated by an employee of that entity 160. Specifically, analyst computing system 168A may be operated by analyst 169A (e.g., an employee of entity 160A); 168B may be operated by analyst 169B, and analyst computing system 168C may be operated by analyst 169C.

Organization 180 may also own, operate, and/or control various computing systems, including computing system 181 and analyst computing system 188. Although computing systems 181 is shown as a single system, computing system 181 is also intended to represent any appropriate computing system or collection of computing systems, and may include a distributed, cloud-based computing system, data center or any other appropriate arrangement. Analyst computing system 188 may be operated by analyst 189 (e.g., an agent or employee of organization 180). Each of the computing systems associated with organization 180 may communicate with other computing systems in FIG. 1A and FIG. 1B over a network (not shown), which may, in some examples, be the internet.

Generally, and for ease of illustration, only a limited number of customers are shown associated with each of entities 160 in FIG. 1A and FIG. 1B. However, in other examples, each of entities 160 may have any number of customers, clients, account holders, or other individuals using services provided by each such entity 160. Similarly, and also for ease of illustration, only a limited number of entities 160, computing systems 161, analyst computing systems 168, organizations 180, computing systems 181, and analyst computing systems 188 are shown in FIG. 1A and FIG. 1B. Techniques described herein may, however, apply to a system involving any number of entities 160 or organizations 180, where each of entities 160 and/or organizations 180 may have any number of computing systems 161, analyst computing systems 168, computing systems 181, and/or analyst computing systems 188.

Each of customers illustrated in FIG. 1A engage in various transactions through their respective bank or entity 160. For instance, customer 110 may use a credit card issued by entity 160A to purchase an item at a merchant, and then later use that same credit card at a restaurant. Customer 110 may then pay a bill using a checking account she maintains entity 160A. As illustrated in FIG. 1A, each of these individual transactions is represented in FIG. 1A by a different instance of transaction data 111A. Sample data included within each of three instances of transaction data 111A is shown in FIG. 1A. Such information may include the identity of the customer, which may be a customer account number or customer number maintained by computing system 161A. Information within each instance of transaction data 111 may also include the type of transaction (e.g., a credit card, debit, or check transaction), the name or identity of the payee, the amount of the transaction, and/or the time and place of the transaction. See illustration of each instance of transaction data 111A in FIG. 1A.

In FIG. 1A, customer 110 also holds accounts at entity 160B, and may engage in a series of transactions (represented by instances of transaction data 111B) using an account she holds at entity 160B. Each transaction may be represented by a different instance of transaction data 111B (shown as a series of instances of transaction data 111B in FIG. 1A).

Other transactions performed by other account holders illustrated in FIG. 1A are also represented in FIG. 1A. For example, customer 120 may engage in series of transactions using his own credit card issued by entity 160A or using a checking account maintained at entity 160A. Each of these individual transactions for customer 120 is represented in FIG. 1A by an instance of transaction data 121A. Customer 120 also engages in a series of transactions using an account he holds at entity 160C (see the series of transaction data 121C in FIG. 1A). Customer 130 similarly performs a series of transactions, and these transactions are represented in FIG. 1A by transaction data 131A. Customer 140 performs transactions using an account held at entity 160B (transaction data 141B), and customer 150 performs transactions using an account held at entity 160C (transaction data 151C).

In operation, computing systems 161 may receive information about transactions performed by one or more customers. For instance, in an example that can be described in the context of FIG. 1A, computing system 161A receives a series of transaction data 111A, corresponding to transactions performed by customer 110. In some examples, computing system 161A receives transaction data 111A over any of a number of different channels. For example, some instances of transaction data 111A may be received by computing system 161A directly from a merchant or other commercial entity (not shown in FIG. 1A). In other cases, one or more instances of transaction data 111A may be received over a network through a third party or from a payment processor (not shown in FIG. 1A). In still other cases, one or more instances of transaction data 111A may be received by computing system 161A over a network from customer 110 or from another entity. For each such transaction, computing system 161A processes transaction data 111A, and in doing so, performs or prepares to perform appropriate funds transfers, accounting records updates, and balance information updates associated with one or more accounts held by customer 110.

Computing system 161A may evaluate each instance of transaction data 111A. For instance, again referring to FIG. 1A, computing system 161A analyzes each instance of transaction data 111A and assesses whether the underlying transaction has any markers or indicia of a fraudulent, illegitimate, or erroneous transaction. Computing system 161A may make such an assessment by evaluating each transaction individually. In other examples, computing system 161A may make such an assessment by considering other transactions performed by customer 110, across any of the products used, lines of business engaged, and/or accounts held by customer 110 at entity 160A. Computing system 161A may thus make the assessment in the context of other transactions. In some examples, other transactions that have similar characteristics, use the same account or account type, or occur in a similar timeframe may be particularly relevant to an evaluation or other assessment for a given transaction. Computing system 161A may perform the assessment by using an algorithm designed to make a conclusive assessment based primarily on transaction data 111A. In other examples, computing system 161A may perform the assessment using an algorithm to highlight potentially problematic transactions, and then computing system 161A may make a definitive assessment of each of instances of transaction data 111A by also considering input of analyst 169A. Analyst 169A may provide such input through analyst computing system 168.

Computing system 161A may, based on its assessment of each instances of transaction data 111A, act on transaction data 111A. For instance, still referring to FIG. 1A, computing system 161 may use the assessment of each of instances of transaction data 111A to determine whether to approve or deny each such underlying transaction. If a transaction is approved, computing system 161A may finalize and/or execute any funds transfers and updates made to accounting records and/or balance information associated with accounts held by customer 110 at entity 160A. If a transaction is denied, computing system 161A may perform fraud mitigation and issue notifications relating to the denied transaction. Such fraud mitigation may include modifications and/or updates to accounting and/or balance information. Notifications relating to the denied transaction may involve computing system 161A sending alerts or other communications to personnel employed by entity 160A (e.g., analyst 169A) and/or to the account holder (i.e., customer 110). Such alerts may provide information about the transaction, may seek additional information about the transaction from customer 110, and/or prompt an analysis of the transaction by fraud analysis personnel (e.g., analyst 169A).

In a similar manner, each of computing systems 161 associated with a respective entity 160 may receive information about transactions performed by one or more of its own customers, and each respective computing system 161 may perform similar operations relating to transactions each has processed on behalf of its corresponding entity 160. For instance, computing system 161B may process transactions performed by each of customers 140 and 110, where such transactions use accounts held at entity 160B. Similarly, computing system 161C may process transactions performed by each of customers 120 and 150 using accounts held at entity 160C. Each of computing system 161B and computing system 161C may also evaluate such transactions and determine whether any transaction shows signs of being a fraudulent, illegitimate, or erroneous transaction. Each of computing system 161B and computing system 161C may act on such evaluations (e.g., approving or deny of the transaction) in a manner similar to that described above in connection with transaction data 111A corresponding to activity of customer 110.

In accordance with one or more aspects of the present disclosure, each of computing systems 161 also generates summarized or abstracted versions of transaction data. For instance, referring again to FIG. 1A, computing system 161A collects instances of transaction data 111A and performs an abstraction operation to generate abstracted transaction data 112A. Such an operation removes from instances of transaction data 111A information that can be used to identify customer 110 (the person responsible for the transactions). In some examples, computing system 161A also groups instances of transaction data 111A into bucketed time periods, so that the transactions occurring during a specific time period are collected within the same bucket. Such time periods may be any appropriate time period, including daily, weekly, monthly, quarterly, or annual transaction buckets. Once bucketed, computing system 161A may summarize the information within each bucket through one or more aggregate functions. In some examples, aggregate functions may be used to avoid including within the summaries specific information about individual transactions. For example, an aggregate function may calculate a count of the number of transactions in a given bucket, calculate an average or median transaction size or amount, and/or identify the type of transaction (e.g., credit card, debit card, wire, other transfer). The count of transactions and/or the number of accounts may also be abstracted, categorized, and/or bucketed (e.g., numbers of accounts might be reported generically as 0-2, 3-7, and 8+, whereas the number of transactions might be generically reported as 0, 1-5, 6-10, or 11+ transactions). In some cases, the generic reporting of transactions might depend on the type of transaction at issue.

Computing system 161A may also perform an abstraction operation on data associated other customers holding accounts at entity 160A, including customer 120 and customer 130. For instance, computing system 161A collects instances of transaction data 121A and produces abstracted transaction data 122A. Similarly, computing system 161A collects instances of transaction data 131A and produces abstracted transaction data 132A. Abstraction operations performed for transaction data 121A and transaction data 131A may be similar to that performed by computing system 161A on transaction data 111A. Accordingly, that computing system 161A may organize or group instances of transaction data 121A and transaction data 131A into respective bucketed time periods, and such buckets might be categorized by transaction type, size, count, or any other appropriate attribute or aggregate characteristic.

Other entities 160 may process transaction information associated with their own customers to remove personally identifiable information, privacy-implicated data, and potentially other types of data. For instance, computing system 161B processes a stream of transaction data 141B (associated with customer 140) to generate abstracted transaction data 142B. Computing system 161B also processes a stream of transaction data 111B (associated with transactions performed by customer 110 using an account held at entity 160B) to generate abstracted transaction data 112B. Similarly, computing system 161C generates an abstracted version of transaction data 121C associated with customer 120C (i.e., abstracted transaction data 122C) and computing system 161C also generates an abstracted version of transaction data 151C associated with customer 150 (i.e., abstracted transaction data 152C).

Data generally represented in FIG. 1A and FIG. 1B as “transaction data” (e.g., transaction data 111A, transaction data 121A, transaction data 111B, etc.) may be mutually beneficial if shared with other lines of business within a given entity 160 or other multiple entities 160. Yet such data also represents and/or includes private customer data, competitive information, and/or trade secret information. If such data is abstracted, it may be easier for each of entities 160 to share the data, and for organization 180 to distribute data from one entity 160 to other entities 160. Abstraction may include creating flags with date and time stamps for specific fraud markers, such as velocity, repeated authorization amounts, geographic disparity, etc., generally and by product. The abstraction may be leveraged to help mitigate fraud by attenuating the fraud losses from a particular event.

Each of computing systems 161 transmit abstracted transaction data to computing system 181. For instance, with reference to FIG. 1A, computing system 161A transmits abstracted transaction data 112A to computing system 181, and also transmits abstracted transaction data 122A and abstracted transaction data 132A (derived from transaction data 121A and transaction data 131A, respectively) to computing system 181. Similarly, computing system 161B transmits abstracted transaction data 142B and 112B to computing system 181. Computing system 161C transmits abstracted transaction data 122C and 152C to computing system 181.

Computing system 181 receives data from each of computing systems 161 and correlates the data to an appropriate customer. For instance, still referring to the example being described in the context of FIG. 1A, computing system 181 receives abstracted transaction data 112A (and other abstracted transaction data) from computing system 161A. Computing system 181 also receives abstracted transaction data 112B (and other abstracted transaction data) from computing system 161B. Computing system 181 evaluates abstracted transaction data 112A and abstracted transaction data 112B and determines that both abstracted transaction data 112A and 112B correspond to transaction data for the same person (i.e., customer 110).

To make such a determination, computing system 181 may determine that abstracted transaction data 112A and 112B both reference a federated identification code (or “federated ID”) associated with customer 110. In some examples, such a federated ID may be a code (e.g., established and/or assigned by organization 180 for new or existing customers) that can be used to correlate data received from any of a number of different entities 160 with a specific person. Accordingly, the federated ID may enable computing system 181 to correlate instances of abstracted transaction data across different entities 160, but the federated ID might be created or chosen in a way that prevents computing system 181 (or any of entities 160) from being able to specifically identify the person associated with abstracted transaction data 112A and 112B. In some examples, the federated ID may be derived from a social security number or account number(s), or other information about the customer, but in general, the federated ID is generated in a manner that does not enable reverse engineering of the customer's identity, social security number, account numbers, or other privacy-sensitive information about the customer. Preferably, since other information included in abstracted transaction data 112A and 112B may have also been processed by computing system 161A and 161B, respectively, no information included in abstracted transaction data 112A and 112B would enable computing system 181 to determine the identity customer 110 or specific details about transaction data 111A and transaction data 111B. However, each of abstracted transaction data 112A and 112B may include information sufficient to enable computing system 181 to correlate abstracted transaction information with a specific person and assess certain attributes about a series of underlying transactions performed by customer 110 using accounts at entity 160A and entity 160B.

In some examples, computing system 181 may include a central repository where each customer's profile may be populated by the member institutions with customer account/transaction information. The customer account/transaction information might not be shared with the other entities 160, thereby preventing any competitive advantage that might be gained by subscribing to information distributed by computing system 181. Accordingly, in most examples, entity 160A would gain no knowledge of the fact that a customer having an account with entity 160A also has accounts with entity 160B.

Computing system 181 may determine, based on data from one or more of computing systems 161, that fraud may be occurring on accounts associated with customer 110. For instance, continuing with the example being described in the context of FIG. 1A, computing system 181 analyzes abstracted transaction data 112A and 112B to determine whether such information has any markers or indicia of a fraudulent, illegitimate, erroneous, or otherwise problematic transactions. Since abstracted transaction data 112A and/or 112B has been abstracted (by computing systems 161A and 161B, respectively) before it was sent to computing system 181, such data might not be as detailed as the underlying transaction data (i.e., transaction data 111A and transaction data 111B). However, abstracted transaction data 112A and 112B does provide a cross-entity view of at least some of the activity associated with accounts held by customer 110 across multiple entities 160. In some examples, computing system 181 determines, based on abstracted transaction data 112A and 112B, that transactions being performed on accounts held by customer 110 at entity 160A and/or entity 160B have signs of fraud.

Computing system 181 may independently make such a determination based on a deterministic algorithm. In other examples, however, computing system 181 may merely determine that fraud is likely occurring on accounts held by customer 110, and rely on a human analyst to confirm the finding. In such an example, computing system 181 may cause analyst computing system 188 to present a user interface intended to be reviewed analyst 189. Based on the review performed by analyst 189 (and input received from analyst computing system 188), computing system 181 may make a determination about whether or not fraud is occurring.

Computing system 181 may notify one or more entities 160 that fraud is occurring on one or more accounts associated with customer 110. For instance, still continuing with the example being described in connection with FIG. 1A, computing system 181 determines that fraud is occurring on one or more accounts held by customer 110. Computing system 181 outputs cross-entity data 113A to computing system 161A. Cross-entity data 113A may take the form of an alert, and may be provided to computing system 161A through a channel established between 181 and 161A to ensure that appropriate personnel or computing systems at entity 160A receives, views, and/or acts on cross-entity data 113A in a timely manner. Computing system 181 may also outputs cross-entity data 113B (also in the form of an alert) to computing system 161B. Each of computing system 161A computing system 161B act on cross-entity data received from computing system 181 in an appropriate manner, such as by denying one or more attempted transactions or ceasing to process transactions for some or all of the accounts customer 110 holds at each of entities 160A and/or 160B. Each of computing system 161A may perform fraud mitigation, which may include sending notifications to analyst computing systems 168A and 168B, which may be monitored by personnel employed by entities 160A and 160B. In some examples, one or more of computing systems 161A or 161B may make modifications and/or updates to accounting and/or balance information. In some examples, the affected account holder (i.e., customer 110) may be contacted for further information or as part of a fraud mitigation process. Further, one or more of analysts 169A and 169B may perform an analysis and take additional appropriate actions.

Note that in the example being described in connection with FIG. 1A, cross-entity data 113A or alerts are sent to computing system 161A and computing system 161B, but no such alerts are sent to computing system 161C. In some examples, computing system 181 transmits alerts, notifications, or other cross-entity data 113 on a need-to-know basis. Since customer 110 does not hold any accounts at entity 160C, and if the fraud or other problematic transactions being described are limited to accounts held by customer 110, entity 160C might not have a need to be notified about potential fraud associated with such transactions. On the other hand, to the extent that there is a higher degree of certainty that one or more entities 160 are being affected by fraud associated with accounts maintained at such institutions, computing system 181 might share more details about the underlying fraud indicators or about the transactions that suggest that fraud is occurring.

In the example described above, computing system 181 provides an alert or other notification to one or more of entities 160 that fraud may be occurring on accounts associated with customer 110. Where fraud is detected or suspected, computing system 181 thus provides information (i.e., cross-entity data 113 in FIG. 1A) about such an assessment. In some cases, however, computing system 181 determines that transactions being performed by accounts held by customer 110 at entity 160A and entity 160B do not show signs of fraud, error, or illegitimacy. In such a situation, computing system 181 might not have a reason to transmit an alert or fraud notification to computing system 161A or computing system 161B.

However, in some examples, whether or not a fraud alert or notification is provided by computing system 181, computing system 181 may nevertheless transmit one or more instances of cross-entity data to certain entities 160 on a need-to-know basis. For instance, computing system 181 may generate, as part of its analysis of instances of abstracted transaction data received from computing systems 161, modeling data or modeling outputs that describe or indicate information about fraud indicators or potential fraud associated with accounts held by customers at one or more of entities 160. Such information about fraud indicators or potential fraud might not be definitive or reflect evidence of actual fraud, so such information might not rise to the level requiring a notification or alert. Yet such information may be of use by one or more of computing systems 161, since such information may be used by one or more of computing systems 161 to enhance their own individual analysis, monitoring, and/or fraud assessment of activity of customers. Therefore, in some examples, computing system 181 may report to one or more of entities 160 cross-entity data that includes modeling information or similar information about various customers, where such modeling information is derived from modeling performed by computing system 181 based on abstracted transaction data received from entities 160.

In some examples, modeling information may take the form of a score (e.g., 0-100), category (green, yellow, red), or rating (“no fraud suspected” or “fraud suspected”) that provides an indication of the results of the fraud assessment performed by computing system 181. Such an assessment might range from “no fraud suspected” (or “green” or “0”) to “fraud suspected” (or “red” or “100”). In some examples, cross-entity data 113 may also include information about the nature of the activity underlying the score, although in other examples, such information might be omitted where it could (or to the extent it could) reveal competitive information about other entities 160. Computing system 181 may modify or clean such modeling information before it is sent to entities 160 to ensure that such modeling information does not provide any information that one or more of entities 160 can use to derive competitive, trade secret, or customer information about other entities 160 provided by computing system 181. But when provided by computing system 181 to each of entities 160, entities 160 may use such modeling information to enhance their own analytics and internal modeling.

Normally, such modeling information may be provided to computing systems 161 in the form of cross-entity data on a need-to-know basis. For example, modeling information pertaining to customer 110 would generally be provided only to computing systems 161 associated with entities 160 where customer 110 holds accounts (i.e., entity 160A and entity 160B).

Computing system 181 may also report abstracted transaction data to one or more of entities 160. For instance, as described above and illustrated in FIG. 1A, computing system 181 receives from each of entities 160 instances of abstracted transaction data summarizing transaction data associated with each of customers across entities 160. If such data is sufficiently abstracted or modified so that no competitive, trade secret, customer information, or other privacy information is included, computing system 181 may, in some examples, distribute such abstracted data (or data derived from the abstracted data) to each of entities 160 (i.e., to each of computing systems 161). Preferably, computing system 181 may send such information on a need-to-know basis, so that abstracted transaction data associated with customer 110 is only sent to those computing systems 161 associated with entities 160 at which customer 110 has other accounts. For those entities 160 where customer 110 does not have an account, computing system 181 may refrain from sharing abstracted transaction data corresponding to transactions performed by customer 110.

Accordingly, in FIG. 1A, since customer 110 holds accounts at both entities 160A and 160B, computing system 181 may include abstracted transaction data 112B or information derived from abstracted transaction data 112B when sending cross-entity data 113A to computing system 161A. Similarly, computing system 181 may include abstracted transaction data 112A or information derived from abstracted transaction data 112A when sending cross-entity data 113B to computing system 161B. In most examples, computing system 181 would not send abstracted transaction data 112A, abstracted transaction data 112B, or information derived from abstracted transaction data 112A or abstracted transaction data 112B to computing system 161C, since customer 110 does not hold any accounts with entity 160C. In some examples, cross-entity data of this nature could be provided to each of entities 160 on a subscription basis. In a manner similar to the modeling data described above, each of computing system 161A and computing system 161B may use such subscription data to enhance their own transaction analysis analytics and modeling. For example, computing system 161A may use such subscription data to augment the data (e.g., transaction data 111A, transaction data 121A, and transaction data 131A) it uses in its analytics and modeling, and may use it to learn more about its own customers, their tendencies, and to more accurately identify potentially erroneous, fraudulent, or illegitimate transactions.

In some examples, each of entities 160 may receive subscription data from computing system 181 at a rate that corresponds in some way to the rate at which each of entities 160 sends data to computing system 181. For example, if computing system 161A sends abstracted transaction data 112A about customer 110, customer 120, and customer 130 to computing system 181 on a monthly basis, computing system 161A might receive subscription data from computing system 181 on a monthly basis.

In the example described above in connection with FIG. 1A, computing system 181 performs cross-entity analysis of transactions performed on accounts held by customer 110 at both entity 160A and entity 160B. Computing system 181 also performs cross-entity analysis of transactions performed on accounts held by other customers across other entities 160. For example, as described herein, customer 120 also holds accounts at multiple entities 160, and FIG. 1B illustrates an example in which computing system 181 performs cross-entity analysis of transactions occurring on accounts held by customer 120 at entity 160A and entity 160C.

As illustrated in FIG. 1B, computing system 181 may receive information about transactions performed by accounts held by customer 120. For instance, as previously described in connection with FIG. 1A, computing system 161A receives a stream of transaction data 121A. Each instance of transaction data 121A represents a transaction performed on an account customer 120 holds at entity 160A. Each instance of transaction data 121A may include details about the underlying transaction, including the type of transaction the merchant or payee involved, the amount of the transaction, the date and time, and/or the geographical location of the transaction. See the illustration of transaction data 121A in FIG. 1B. Computing system 161A performs an abstraction operation to generate abstracted transaction data 122A. Computing system 161A communicates abstracted transaction data 122A to computing system 181. Similarly, computing system 161C receives a stream of transaction data 121C, and generates abstracted transaction data 122C. Computing system 161C communicates abstracted transaction data 122C to computing system 181.

Computing system 181 may send cross-entity data to each of computing systems 161A and 161C. For instance, referring again to FIG. 1B, computing system 181 analyzes abstracted transaction data 122A and abstracted transaction data 122C and determines, based on a federated ID or other information, that abstracted transaction data 122A and abstracted transaction data 122C correspond to transactions performed by the same person (i.e., customer 120). Computing system 181 further analyzes abstracted transaction data 122A and abstracted transaction data 122C for signs of fraud or other problems. Based on such analysis, computing system 181 may communicate cross-entity data 123A to computing system 161A, and computing system 181 may communicate cross-entity data 123C to computing system 161C. In some examples, cross-entity data 123A and cross-entity data 123C may include alert or notifications, indicating that fraud has been detected or is likely. In other examples, cross-entity data 123A and cross-entity data 123C may include modeling data or modeling output information that is based on analysis performed by computing system 181. In other examples, cross-entity data 123A and cross-entity data 123C may include abstracted transaction data describing transactions performed by customer 120 at other entities 160. Such abstracted transaction data might be provided by computing system 181 to each of computing system 161A and computing system 161C on a subscription basis, and may be provided at a frequency that corresponds to the frequency at which each of computing system 161A and computing system 161C provides its own abstracted transaction data to computing system 181.

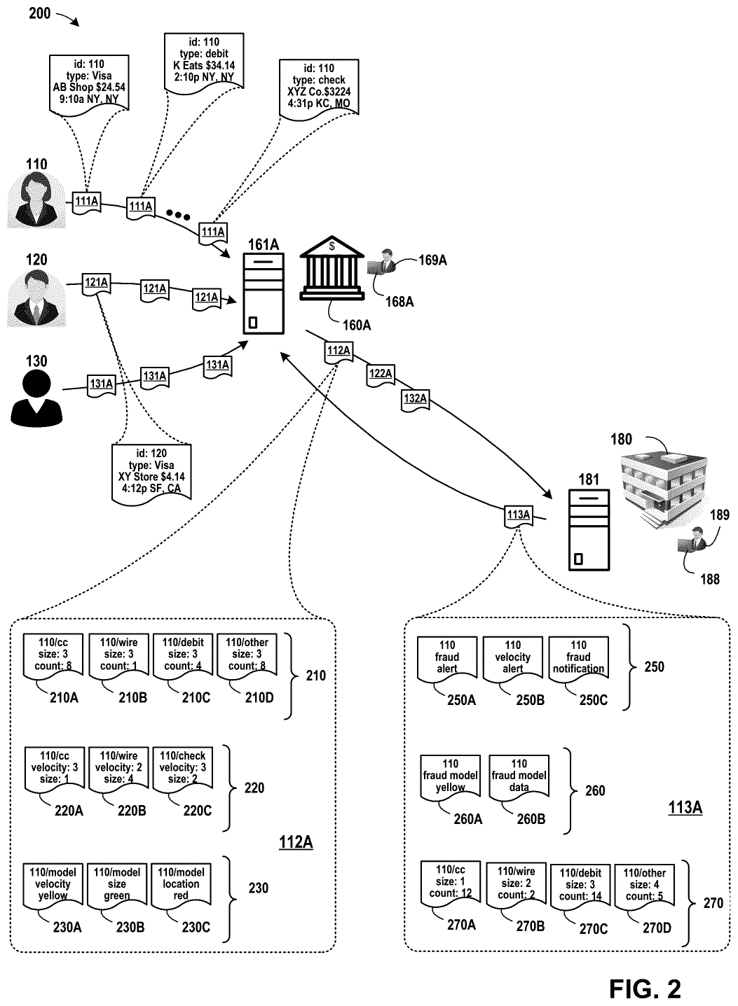

FIG. 2 is a conceptual diagram illustrating examples of transaction data, abstracted transaction data, and cross-entity data, in accordance with one or more aspects of the present disclosure. FIG. 2 illustrates a portion of FIG. 1A, and FIG. 2 may be considered an example or alternative implementation of aspects of system 100 of FIG. 1A. In the example of FIG. 2, system 100 includes many of the same elements described in FIG. 1A and FIG. 1B, and elements illustrated in FIG. 2 may correspond to earlier-illustrated elements that are identified by like-numbered reference numerals. In general, such like-numbered elements may represent previously-described elements in a manner consistent with prior descriptions.

As described in connection with FIG. 1A and FIG. 1B, each instance of transaction data 111A corresponds, in general, to a specific underlying transaction performed by customer 110 using an account that customer 110 holds at entity 160A. Each instance of transaction data 111A may include details about the underlying transaction, including the type of transaction, the merchant or payee involved, the amount of the transaction, the date and time, and/or the geographical location of the transaction. Similarly, each instance of transaction data 121A corresponds to details about an underlying transaction performed by customer 120 using an account that customer 120 holds at entity 160A. Like transaction data 111A, each instance of transaction data 121A may include details about the underlying transaction. Also, each instance transaction data 131A corresponds, in a similar way, to an underlying transaction performed by customer 130 using an account that customer 130 holds at entity 160A.

Abstracted transaction data 112A is derived from the series of transaction data 111A, and may include several types of data. For example, as shown in FIG. 2, abstracted transaction data 112A may include periodic abstracted transaction data 210, non-periodic abstracted transaction data 220, and model data 230.

Periodic abstracted transaction data 210 may represent information that computing system 161A reports to computing system 181 on an occasional, periodic, or other schedule. Abstracted transaction data 210 may be composed of several instances of data (e.g., periodic abstracted transaction data 210A, 210B, and 210C). Each instance of periodic abstracted transaction data 210 may represent a collection of transactions (e.g., instances of transaction data 111A) that have been bucketed into a group. In the example of FIG. 2, such transactions can be categorized or bucketed into a group by time frame, which may be a daily, weekly, monthly, quarterly, annual, or other time frame. Each instance of periodic abstracted transaction data 210 may represent a transaction type. Periodic abstracted transaction data 210A may represent a bucket of transaction data 111A derived from credit card transactions. In the example shown, periodic abstracted transaction data 210A identifies the customer associated with the transactions (i.e., customer 110), the size of the transactions (i.e., representing a dollar value), and the number of transactions in that bucket. Similarly, periodic abstracted transaction data 210B represents a bucket of transaction data 111A derived from wire transactions, where periodic abstracted transaction data 210B also identifies the customer, size category of the transactions, and transaction count. Periodic abstracted transaction data 210C and periodic abstracted transaction data 210D represent buckets of debit card transactions and other transactions, respectively.

Non-periodic abstracted transaction data 220 may represent information that computing system 161A might not report on any regular or irregular schedule. As illustrated in FIG. 2, non-periodic abstracted transaction data 220 may include several instances or type of data, including non-periodic abstracted transaction data 220A, 220B, and 220C. In the example shown, non-periodic abstracted transaction data 220 may represent data about transaction velocity. Although velocity could be reported by to computing system 181 on a periodic basis, velocity data generally describes information about the time between transactions. Since a high velocity (corresponding to a short time between transactions) tends to suggest fraud is actively occurring, it may be more appropriate to report such data as it occurs or in another appropriate way, rather than reporting such data periodically. Accordingly, non-periodic abstracted transaction data 220 may represent data, such as velocity data, that may be reported on an as-appropriate (or “non-periodic”) basis. As illustrated in FIG. 2, non-periodic abstracted transaction data 220 may be reported by transaction type (e.g., non-periodic abstracted transaction data 220A provides credit card transaction velocity data, non-periodic abstracted transaction data 220B provides wire transaction velocity data, and non-periodic abstracted transaction data 220C provides checking account velocity data). In some examples, non-periodic abstracted transaction data 220 may include a velocity score or rate (e.g., “velocity: 3”), and a size categorization for transactions associated with that velocity score or rate. Additional data may be included within instances of non-periodic abstracted transaction data 220, and other categorizations of such non-periodic abstracted transaction data 220 may be used in other examples.

Model data 230 may include information generated by an analysis of transaction data 111A by computing system 161, and may include information about fraud scores, velocity trends, unusual transactions, and other information. Model data 230 may be composed of model data 230A, 230B, and model data 230C. Computing system 161A may report model data 230 to computing system 181 to share its conclusions about activity associated with customer 110, and may be useful to computing system 181 even where computing system 161A has not identified any fraud. For example, model data 230A may include information about transaction velocity for one or more of the accounts held by customer 110 at entity 160A, and may include a score or category (e.g., “green,” “yellow,” “red”) that describes conclusions reached by models run by computing system 161A about velocity. In FIG. 2, model data 230A may represent a moderately high velocity modeling score that is not sufficiently high to prompt fraud mitigation actions to be taken by computing system 161A. If reported to computing system 181, however, computing system 181 may be in a position to see model data 230A in a more revealing context. For instance, if computing system 181 sees similarly high velocity modeling scores for accounts held by customer 110A across multiple entities 160, computing system 181 may determine that the collective effect of such velocity characteristics warrants mitigation action to be taken (e.g., thereby prompting an alert to be sent to computing system 161A by computing system 181). Other instances of model data 230 may include model data 230B (e.g., representing modeling information relating to transaction size) and model data 230C (e.g., representing modeling information relating to the geographic location associated with transactions underlying transaction data 111A). Although model data 230 is described with respect to velocity, size, and location, other types of modeling data are possible.

FIG. 2 also illustrates that cross-entity data 113A may also include several types of data. As shown in FIG. 2, cross-entity data 113A may include cross-entity alerts 250, cross-entity model information 260, and cross-entity subscription data 270.

Cross-entity alerts 250 may represent notifications or alerts sent by computing system 181 to one or more of computing systems 161, providing information that may prompt action by one or more of computing systems 161. In the example of FIG. 2, cross-entity alerts 250A, 250B, and 250C (collectively “cross-entity alerts 250”) may indicate that computing system 181 has concluded that fraudulent, illegitimate, highly unusual, or erroneous are taking place on one or more accounts associated accounts held by customer 110 at entity 160A. In some examples, one or more instances of cross-entity alerts 250 may simply provide information about potential fraud that could affect customer 110, but might not require immediate action to mitigate fraud (e.g., cross-entity alert 250C). In such an example, cross-entity alert 250C may serve more as a notification. Each of cross-entity alerts 250 may identify customer 110 (e.g., by federated ID) and the type of issue each pertains to (“fraud” for cross-entity alerts 250A and 250C, and “velocity” for cross-entity alert 250B). Although cross-entity alerts 250 are shown being sent by computing system 181 to computing system 161A, in other examples, such cross-entity alerts 250 may be sent by computing system 181 to other destinations, including analyst computing system 168A, to a computing device operated by customer 110, or to another device. In some examples, one or more of cross-entity alerts 250 may prompt computing system 161A to take action to mitigate any fraud or other effects of transactions taking place on accounts held by customer 110.

Cross-entity model information 260 may represent information about hypotheses or conclusions reached by computing system 181 as a result of analyses performed by computing system 181. For example, cross-entity model information 260A may represent a conclusion reached by computing system 181 about fraud associated with accounts held by customer 110. In FIG. 2, cross-entity model information 260A includes a “yellow” designation, which might represent a mid-level risk associated with accounts held by customer 110. Cross-entity model information 260A may be based on analysis performed by computing system 181 across multiple accounts held by customer 110. In such an example, computing system 181 may have evaluated abstracted transaction data 112A (received form computing system 161A) and abstracted transaction data 112B (received from computing system 161B) to make a cross-entity assessment about fraud for customer 110. Cross-entity model information 260B might represent data associated with such an assessment, and may include aspects of the data used to reach the conclusion represented by cross-entity model information 260A, such as underlying scores or modeling information used by computing system 181 to reach such conclusions. If reported to computing system 161A, computing system 161A may use such cross-entity model information 260 to augment its own modeling or analysis performed when evaluating transaction data 111A. Cross-entity model information 260 is preferably communicated to computing system 161A in a manner that identifies the customer to which it pertains (i.e., customer 110) without providing any competitive information about accounts held by customer 110 at other entities 160, or even the identity of which of entities 160 customer 110 might hold such other accounts.

Cross-entity subscription data 270 may correspond to one or more instances of abstracted transaction data about customer 110, where such abstracted transaction data was received by computing system 181 from one or more other entities 160. In other words, in one example, cross-entity subscription data 270, as sent by computing system 181 to computing system 161A, may correspond to or be derived from abstracted transaction data 112B sent to computing system 181 by computing system 161B. Accordingly, cross-entity subscription data 270 may have a form similar to periodic abstracted transaction data 210 (i.e., each of cross-entity subscription data 270A, 270B, 270C, and 270D may be of the same type or form as periodic abstracted transaction data 210A, 210B, 210C, and 210D).

Cross-entity subscription data 270 may represent bucketed information about specific transaction types. As shown in FIG. 2, cross-entity subscription data 270A reports information about card transactions performed on accounts held by customer 110 at, for example, entity 160B. Similarly, cross-entity subscription data 270B reports information about wire transactions performed on accounts held by customer 110. Cross-entity subscription data 270C reports information about debit card transactions, and cross-entity subscription data 270D reports information about other types of transactions. Each instance of cross-entity subscription data 270 may represent a collection of transactions that have been bucketed into a group, such as by time frame. Each instance of cross-entity subscription data 270 may identify the customer associated with the transactions, the size of the transactions, and the number of transactions in that bucket. As described above, computing system 161A might receive cross-entity subscription data 270 on a subscription/periodic basis, at a frequency which may correspond to the frequency at which computing system 161A provides its own periodic abstracted transaction data 210 (i.e., abstracted transaction data 112A). Cross-entity subscription data 270 may be used by computing system 161A to augment the private data (e.g., transaction data 111A) it uses in its analytics and modeling for customer 110 and to enhance its transaction analysis analytics and modeling operations.

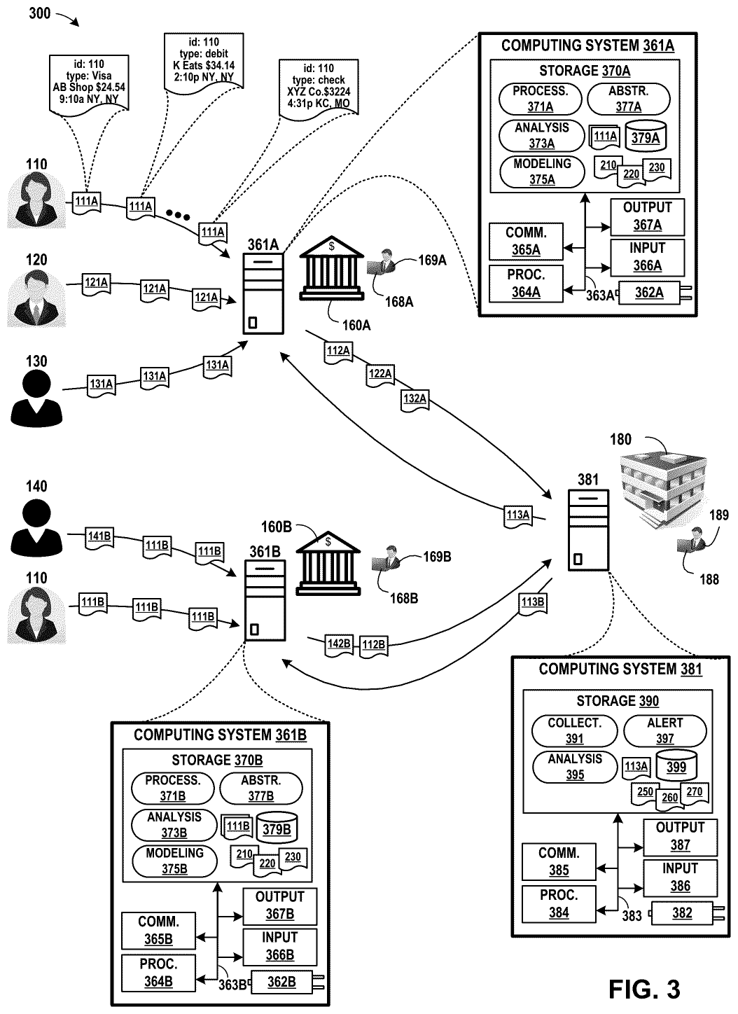

FIG. 3 is a block diagram illustrating an example system in which multiple entities provide data to an organization to enable cross-entity analysis of such data, in accordance with one or more aspects of the present disclosure. FIG. 3 may be described as an example or alternative implementation of system 100 of FIG. 1A and FIG. 1B. In the example of FIG. 3, system 300 includes many of the same elements described in FIG. 1A and FIG. 1B, and elements illustrated in FIG. 3 may correspond to earlier-illustrated elements that are identified by like-numbered reference numerals. In general, such like-numbered elements may represent previously-described elements in a manner consistent with prior descriptions, although in some examples, such elements may be implemented differently or involve alternative implementations with more, fewer, and/or different capabilities and/or attributes. One or more aspects of FIG. 3 may be described herein within the context of FIG. 1A, FIG. 1B, and FIG. 2.

Computing system 381, illustrated in FIG. 3, may correspond to computing system 181 of FIG. 1A, FIG. 1B, and FIG. 2. Similarly, computing system 361A and computing system 361B (collectively, “computing systems 361”) may correspond to earlier-illustrated computing system 161A and computing system 161B, respectively. These devices, systems, and/or components may be implemented in a manner consistent with the description of the corresponding system provided in connection with FIG. 1A and FIG. 1B, although in some examples such systems may involve alternative implementations with more, fewer, and/or different capabilities. For ease of illustration, only computing system 361A and computing system 361B are shown in FIG. 3. However, any number of computing systems 361 may be included within system 300, and techniques described herein may apply to a system having any number of computing systems 361 or computing systems 381.

Each of computing system 381, computing system 361A, and computing system 361B may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, any of computing systems 381, 361A, and/or 361B may represent a cloud computing system, server farm, and/or server cluster (or portion thereof) that provides services to client devices and other devices or systems. In other examples, such systems may represent or be implemented through one or more virtualized compute instances (e.g., virtual machines, containers) of a data center, cloud computing system, server farm, and/or server cluster.

In the example of FIG. 3, computing system 381 may include power source 382, one or more processors 384, one or more communication units 385, one or more input devices 386, one or more output devices 387, and one or more storage devices 390. Storage devices 390 may include collection module 391, analysis module 395, alert module 397, and data store 399. Data store 399 may store various data described elsewhere herein, including, for example, various instances of abstracted transaction data and cross-entity data, as well as one or more cross-entity alerts 250, cross-entity model information 260, and/or cross-entity subscription data 270.

Power source 382 may provide power to one or more components of computing system 381. Power source 382 may receive power from the primary alternating current (AC) power supply in a building, home, or other location. In other examples, power source 382 may be a battery or a device that supplies direct current (DC). In still further examples, computing system 381 and/or power source 382 may receive power from another source. One or more of the devices or components illustrated within computing system 381 may be connected to power source 382, and/or may receive power from power source 382. Power source 382 may have intelligent power management or consumption capabilities, and such features may be controlled, accessed, or adjusted by one or more modules of computing system 381 and/or by one or more processors 384 to intelligently consume, allocate, supply, or otherwise manage power.

One or more processors 384 of computing system 381 may implement functionality and/or execute instructions associated with computing system 381 or associated with one or more modules illustrated herein and/or described below. One or more processors 384 may be, may be part of, and/or may include processing circuitry that performs operations in accordance with one or more aspects of the present disclosure. Examples of processors 384 include microprocessors, application processors, display controllers, auxiliary processors, one or more sensor hubs, and any other hardware configured to function as a processor, a processing unit, or a processing device. Computing system 381 may use one or more processors 384 to perform operations in accordance with one or more aspects of the present disclosure using software, hardware, firmware, or a mixture of hardware, software, and firmware residing in and/or executing at computing system 381.

One or more communication units 385 of computing system 381 may communicate with devices external to computing system 381 by transmitting and/or receiving data, and may operate, in some respects, as both an input device and an output device. In some examples, communication unit 385 may communicate with other devices over a network. In other examples, communication units 385 may send and/or receive radio signals on a radio network such as a cellular radio network. In other examples, communication units 385 of computing system 381 may transmit and/or receive satellite signals on a satellite network such as a Global Positioning System (GPS) network.

One or more input devices 386 may represent any input devices of computing system 381 not otherwise separately described herein. One or more input devices 386 may generate, receive, and/or process input from any type of device capable of detecting input from a human or machine. For example, one or more input devices 386 may generate, receive, and/or process input in the form of electrical, physical, audio, image, and/or visual input (e.g., peripheral device, keyboard, microphone, camera).

One or more output devices 387 may represent any output devices of computing systems 381 not otherwise separately described herein. One or more output devices 387 may generate, receive, and/or process output from any type of device capable of outputting information to a human or machine. For example, one or more output devices 387 may generate, receive, and/or process output in the form of electrical and/or physical output (e.g., peripheral device, actuator).

One or more storage devices 390 within computing system 381 may store information for processing during operation of computing system 381. Storage devices 390 may store program instructions and/or data associated with one or more of the modules described in accordance with one or more aspects of this disclosure. One or more processors 384 and one or more storage devices 390 may provide an operating environment or platform for such modules, which may be implemented as software, but may in some examples include any combination of hardware, firmware, and software. One or more processors 384 may execute instructions and one or more storage devices 390 may store instructions and/or data of one or more modules. The combination of processors 384 and storage devices 390 may retrieve, store, and/or execute the instructions and/or data of one or more applications, modules, or software. Processors 384 and/or storage devices 390 may also be operably coupled to one or more other software and/or hardware components, including, but not limited to, one or more of the components of computing system 381 and/or one or more devices or systems illustrated as being connected to computing system 381.

In some examples, one or more storage devices 390 are temporary memories, which may mean that a primary purpose of the one or more storage devices is not long-term storage. Storage devices 390 of computing system 381 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 390, in some examples, also include one or more computer-readable storage media. Storage devices 390 may be configured to store larger amounts of information than volatile memory. Storage devices 390 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Collection module 391 may perform functions relating to receiving instances of abstracted transaction data from one or more of computing systems 361, and to the extent such information is stored, storing information into data store 399. Collection module 391 may expose an API (application programming interface) that one or more of computing systems 361 engage to upload instances of abstracted transaction data. In some examples, collection module 391 may specify and/or define the form in which instances of abstracted transaction data should be uploaded, and at least in that sense, computing system 181 may define or mandate the disclosure of certain attributed of abstracted data received from computing systems 361, and/or may define or mandate the format in which such data is transmitted by each of computing systems 361.

Analysis module 395 may perform functions relating to analyzing instances of abstracted transaction data received from one or more of computing systems 361 to determine whether such data has any markers or indicia indicating fraudulent, illegitimate, erroneous, or otherwise problematic transactions. In some cases analysis module 395 may perform such an analysis in the context of transaction velocity, transaction repletion, transaction type repetition, device type used to perform the transactions, and/or the locations at which transactions were performed. Analysis module 395 also performs such analysis by considering transactions occurring on accounts across multiple entities 160.

Alert module 397 may perform functions relating to reporting information to one or more computing systems 361. Such information may include cross-entity alert 250, cross-entity model information 260, and/or cross-entity subscription data 270.

Data store 399 may represent any suitable data structure or storage medium for storing information related to survey results (e.g., questions posed, answers, users polled, time polled). The information stored in data store 399 may be searchable and/or categorized such that one or more modules within computing system 381 may provide an input requesting information from data store 399, and in response to the input, receive information stored within data store 399. Data store 399 may be primarily maintained by collection module 391.

In the example of FIG. 3, computing system 361A may include power source 362A, one or more processors 364A, one or more communication units 365A, one or more input devices 366A, one or more output devices 367A, and one or more storage devices 370A. Storage devices 370A may include transaction processing module 371A, analysis module 373A, modeling module 375A, abstraction module 377A, and data store 379A. Data store 379A may store data described herein, including, for example, various instances of transaction data and abstracted transaction data. Similarly, computing system 361B may include power source 362B, one or more processors 364B, one or more communication units 365B, one or more input devices 366B, one or more output devices 367B, and one or more storage devices 370B.

Certain aspects of computing systems 361 are described below with respect to computing system 361A. For example, power source 362A may provide power to one or more components of computing system 361A. One or more processors 364A of computing system 361A may implement functionality and/or execute instructions associated with computing system 361A or associated with one or more modules illustrated herein and/or described below. One or more communication units 365A of computing system 361A may communicate with devices external to computing system 361A by transmitting and/or receiving data over a network or otherwise. One or more input devices 366A may represent any input devices of computing system 361A not otherwise separately described herein. Input devices 366A may generate, receive, and/or process input, and output devices 367A may represent any output devices of computing system 361A. One or more storage devices 370A within computing system 361A may store program instructions and/or data associated with one or more of the modules of storage devices 370A in accordance with one or more aspects of this disclosure. Each of these components, devices, and/or modules may be implemented in a manner similar to or consistent with the description of other components or elements described herein.

Transaction processing module 371A may perform functions relating to processing transactions performed by one or more of customers using accounts held at one or more of entities 160. Analysis module 373A may perform functions relating to analyzing transaction data and determining whether one or more underlying transactions has signs of fraud or other issues. Modeling module 375A may perform modeling functions, which may include training, evaluating, and/or applying models (e.g., machine learning models) to evaluate transactions, customer behavior, or other aspects of customer activity. Abstraction module 377A may perform functions relating to processing transaction data to remove personally-identifiable data and other data having privacy implications. Data store 379A is a data store for storing various instances of data generated and/or processed by other modules of computing system 361A.

Descriptions herein with respect to computing system 361A may correspondingly apply to one or more other computing systems 361. Other computing systems 361 (e.g., computing system 361B and others, not shown) may therefore be considered to be described in a manner similar to that of computing system 361A, and may also include the same, similar, or corresponding components, devices, modules, functionality, and/or other features.

In accordance with one or more aspects of the present disclosure, computing system 361A of FIG. 3 may store information about transactions performed on accounts associated with customer 110. For instance, in an example that can be described in connection with FIG. 3, communication unit 365A of computing system 361A detects a signal over a network. Communication unit 365A outputs information about the signal to transaction processing module 371A. Transaction processing module 371A determines that the signal includes information about a transaction performed on an account held by customer 110 at entity 160A. In some examples, the information includes details about a financial transaction, such as merchant name or identifier, a transaction amount, time, and/or location. Transaction processing module 371A stores information about the transaction in data store 379A (e.g., as transaction data 111A). Computing system 361A may receive additional instances of transaction data associated with transactions performed on accounts held by customer 110 at entity 160A, and each such instance may be similarly processed by transaction processing module 371A and stored as an instance of transaction data 111A in data store 379A.

Computing system 361A may store information about transactions performed by other customers. For instance, still referring to FIG. 3, communication unit 365A of computing system 361A again detects a signal over a network, and outputs information about the input to transaction processing module 371A. Transaction processing module 371A determines that the signal includes information about a transaction performed by another client, customer, or account holder at entity 160A, such as customer 120. Transaction processing module 371A stores the information about the transaction in data store 379A (e.g., as transaction data 121A). Transaction processing module 371A may also receive additional instances of transaction data corresponding to other transactions performed on accounts held at entity 160A by customer 120. Each time, transaction processing module 371A stores such instances of transaction data as transaction data 121A in data store 379A. In general, transaction processing module 371A may receive a series of transaction information associated with transactions performed on accounts held by any number of customers of entity 160A (e.g., customers 110, 120, 130, etc.), and in each case, transaction processing module 371A of computing system 361A may process such information and store a corresponding instance of transaction data.

Computing system 361B, also illustrated in FIG. 3, may operate similarly. For instance, transaction processing module 371B of computing system 361B may receive a series of transaction information associated with accounts held by customers of entity 160B. Transaction processing module 371B may process such information and store a corresponding instance of transaction data in data store 379B.

Computing system 361A may analyze and/or model various instances of transaction data. For instance, still referring to the example being described in the context of FIG. 3, modeling module 375A accesses data store 379A and retrieves various instances of transaction data. In general, modeling module 375A may evaluate transaction data associated with each of its customers. May assess the size, velocity, and accounts associated with such transaction data and use that information to determine whether any fraudulent, illegitimate, and/or erroneous transactions have occurred for any of the customers of entity 160A. Modeling module 375A may cause transaction processing module 371A and/or analysis module 373A to act on assessments performed by modeling module 375A, which may involve computing system 361A limiting use of one or more accounts at entity 160A and/or issuing alerts and/or notifications to be seen by one or more analysts 169 and/or customers.

In some examples, modeling module 375A may train and/or continually retrain a machine learning model to make fraud and other assessments for transactions occurring on any of the accounts at entity 160A. For instance, modeling module 375A may develop a model of behavior associated with one or more of customers 110, 120, and/or 130. Such a model may enable computing system 361A (or analysis module 373A) to determine when transactions might be unusual, erroneous, fraudulent, or otherwise improper.

Computing system 361A may process instances of transaction data to generate generalized or abstracted categories of transactions. For instance, referring again to FIG. 3, abstraction module 377A of computing system 361A accesses data store 379A. Abstraction module 377A retrieves information about transactions performed by customer 110, which may be stored as instances of transaction data 111A. Abstraction module 377A removes from instances of transaction data 111A information that can be used to identify customer 110 (i.e., the person or customer that performed the transaction). Abstraction module 377A may also remove from transaction data 111A information about account numbers, account balances, personally-identifiable information, or other privacy-implicated data. In some examples, abstraction module 377A groups instances of transaction data 111A into bucketed time periods, so that the transactions occurring during a specific time period are collected within the same bucket. Such time periods may correspond to any appropriate time period, including daily, weekly, monthly, quarterly, or annual transaction buckets.

Abstraction module 377A may further abstract the information about the transactions within a specific bucket by identifying a count of the number of transactions in the bucket, and may also identify the type of transaction associated with that count. For instance, in some examples, abstraction module 377A organizes transaction information so that one bucket includes all the credit card transactions for a given month, and the attributes of the bucket may be identified by identifying the type of transaction (i.e., credit card) and a count of the number of transactions in that bucket for that month. Transactions can be categorized in any appropriate manner, and such categories or types of transaction might be credit card transactions, checking account transactions, wire transfers, debit card or other direct transfers from a deposit account, brokerage transactions, cryptocurrency transactions (e.g., Bitcoin), or any other type of transaction. Abstraction module 377A may also associate a size with the transactions within the bucket, which may represent an average, median, or other appropriate metric associated with the collective or aggregate size of the transactions in the bucket. In some examples, abstraction module 377A may create different buckets for a given transaction type and a given time frame. Abstraction module 377A stores such information within data store 379A (e.g., as abstracted transaction data 112A or periodic abstracted transaction data 210).

Computing system 361A may also generate information about the velocity of transactions performed by customer 110. For instance, still referring to FIG. 3, abstraction module 377A evaluates the timeframe over which various transactions (as indicated by transaction data 111A) were performed on accounts held by customer 110. Abstraction module 377A determines a velocity attribute based on the timeframes of such transactions. Abstraction module 377A generates the velocity attribute without including personally-identifiable information, and without including information about specific accounts associated with the velocity of transactions. Abstraction module 377A stores such information within data store 379A as non-periodic abstracted transaction data 220.

Computing system 361A may generate abstracted modeling information that may be shared with computing system 181. For instance, referring again to FIG. 3, abstraction module 377A receives information from modeling module 375A about models developed by modeling module 375A. Such models may have been developed by modeling module 375A to assess risk and/or to make fraud assessments for accounts held by customers at entity 160A. Abstraction module 377A organizes the information about models, which may include outputs or conclusions reached by the models, but could also include parameters, and/or data associated underlying or used to develop such models. Abstraction module 377A modifies the information to remove personally-identifiable information and other information that might be proprietary to entity 160A (e.g., information about number and types of accounts held by customer 110). Abstraction module 377A stores such information within data store 379 as model data 230.

Computing system 361A may share abstracted transaction information with computing system 381. For instance, still referring to the example being described in connection with FIG. 3, abstraction module 377A of computing system 361A causes communication unit 365A to output a signal over a network. Similarly, abstraction module 377B of computing system 361B causes communication unit 365B to output a signal over the network. Communication unit 385 of computing system 381 detects signals over the network and outputs information about the signals to collection module 391. Collection module 391 determines that the signals correspond to abstracted transaction data 112A from computing system 361A and abstracted transaction data 112B from computing system 361B. In some examples, collection module 391 causes computing system 381 to process the data and discard it, thereby helping to preserve the privacy of the data. In other examples, collection module 391 stores at least some aspects of abstracted transaction data 112A and 112B within data store 399.

Computing system 381 may correlate data received from each of entities 160. Analysis module 395 of computing system 381 determines that new instances of abstracted transaction data have been received by collection module 391 and/or stored within data store 399. Analysis module 395 accesses abstracted transaction data 112A and 112B and determines that each of abstracted transaction data 112A and 112B relate to transactions performed at accounts held by the same person (i.e., customer 110). Analysis module 395 may make such a determination by correlating a federated ID or other identifier included within each instance of abstracted transaction data 112A and 112B. Analysis module 395 may similarly correlate other abstracted transaction data received from other entities 160 to identify data associated with customer 110, who may hold accounts at multiple entities 160.

Computing system 381 may analyze correlated data. For instance, continuing with the example being described with reference to FIG. 3, analysis module 395 analyzes abstracted transaction data 112A and 112B to determine whether any fraudulent, illegitimate, or erroneous transactions have occurred. In some examples, analysis module 395 may assess the size, velocity, and accounts associated with relevant transaction data and use that information to determine whether any fraudulent, illegitimate, and/or erroneous transactions have occurred for accounts associated with customer 110. Analysis module 395 may also assess transaction repletion, transaction type repetition, device type used to perform transactions, etc. In general, analysis module 395 may evaluate transaction data associated with each customer associated with any of entities 160.

In some examples, computing system 381 may apply one or more models to the transaction data associated with accounts maintained by entities 160. For instance, again referring to FIG. 3, and in some examples, analysis module 395 may perform an assessment of any of the transaction data associated with accounts maintained by entities 160. Such an assessment is performed by analysis module 395 based on abstracted transaction data received from each of entities 160. Such models may determine whether the transaction data is consistent with past spending and/or financial activity practices associated with a given customer (e.g., any of customers 110, 120, and/or 130). In other words, analysis module 395 may determine whether transactions performed by a specific customer is considered “normal” or is in one or more ways inconsistent with prior activities performed by each such customer. For example, analysis module 395 may apply a model to abstracted transaction data 112A and abstracted transaction data 112B to make an assessment of accounts held by customer 110 at entity 160A and entity 160B. In some examples, analysis module 395 may generate a score for customer 110 (or other customers) that quantifies the activity of such customers relative to normal. In one example, analysis module 395 might generate a set of categories or range of values for each such customer, quantifying the activity of each such customer. Categories might range from green (normal) to yellow (a little unusual) to red (abnormal), whereas a score might range from 0 (normal) to 100 (abnormal). In some examples, a model used by computing system 381 may use human input (e.g., through analyst computing system 188, operated by analyst 189) to help assess whether a given set of activity is normal, unusual, or abnormal.

One or more of computing systems 361 may act on information received from computing system 381. For instance, still with reference to FIG. 3, analysis module 395 determines, based on its own analysis and/or that of a model executed by computing system 381, that one or more of the transactions performed on an account held by customer 110 is (or are likely to be) fraudulent, illegitimate, erroneous, or otherwise improper. Analysis module 395 outputs information to alert module 397. Alert module 397 causes communication unit 385 to output a signal over a network destined to computing system 361A. Communication unit 365A of computing system 361A detects a signal over the network. Communication unit 365A outputs information about the signal to analysis module 373A. Analysis module 373A determines, based on the information, that fraud is likely occurring on accounts held by customer 110 (i.e., either at entity 160A or at a different entity 160). Analysis module 373A takes action to prevent improper transactions at entity 160A. Analysis module 373A may, for example, cease processing transactions for accounts associated with customer 110 for certain products (e.g., credit cards, wire transfers).

Similarly, computing system 381 may communicate with computing system 361B, providing information suggesting fraud may be occurring on accounts held by customer 110. Computing system 361B may, in response, also take action to prevent improper transactions (or further improper transactions) on accounts held by customer 110 at entity 160B. Such actions may involve suspending operations of credit cards or other financial products for accounts held by customer 110, or limiting such use.

In some examples, computing system 381 may additionally notify an analyst of potential fraud. For instance, continuing with the example being described in connection with FIG. 3, and in response to determining that transactions performed on an account held by customer 110 may be improper, analysis module 395 may cause communication unit 385 to output a signal over a network to analyst computing system 188. Analyst computing system 188 detects a signal and in response, generates a user interface presenting information identifying the potentially fraudulent, illegitimate, or erroneous transactions occurring on an account held by customer 110. Analyst computing system 188 may detect interactions with the user interface, reflecting input by analyst 189. In some cases, analyst computing system 188 may interpret such input as an indication to override fraud assessment. In such an example, analyst computing system 188 may interact with computing system 381, computing system 361A, and/or computing system 361B to prevent or halt the cessation of transaction processing associated with accounts held by customer 110. In other cases, however, analyst computing system 188 may interpret input by analyst 189 as not overriding the fraud assessment, in which case computing system 361A and/or computing system 361B may continue with fraud mitigation operations.

In some examples, computing system 381 may alternatively, or in addition, communicate with analyst computing system 168A and/or analyst computing system 168B about potential fraud. For instance, again referring to FIG. 3, computing system 381 may communicate information to analyst computing system 168A and analyst computing system 168B. Each of analyst computing systems 168A and 168B may use such information to generate a user interface presenting information about potential fraud associated with accounts held by customer 110. Analyst computing system 168A may detect interactions with the user interface it presents, reflecting input by analyst 169A. Analyst computing system 168A may interpret such input as an indication to either override or not override the fraud assessment, and in response, analyst computing system 168A may act accordingly (e.g., enabling computing system 361A to mitigate fraud). Similarly, analyst computing system 168Ba may detect interactions with the user interface it presents, reflecting input by analyst 169B. Analyst computing system 168B may interpret such input as an indication to either override or not override the fraud assessment, and analyst computing system 168B may act accordingly. Since computing system 361A and computing system 361B may receive different data from computing system 381, and since each of analyst 169A and analyst 169B may make different assessments of the data each evaluates, computing system 361A and computing system 361B may respond to communications from computing system 381 differently.

In addition, and in some examples, computing system 381 may notify customers of potential fraud. For instance, again referring to FIG. 3, computing system 381 may cause communication unit 385 to output a signal over a network that causes a notification to be presented to a computing device (e.g., mobile device) used by customer 110. Such a notification may indicate that transactions processing has been limited or stopped for certain accounts held by customer 110. The notification may invite customer 110 to participate in a conversation or other interaction with personnel employed by entity 160A (or entity 160B) about the potentially improper transactions.

The above examples outline operations taken by computing system 381, computing system 361A, and/or computing system 361B in scenarios in which transactions occurring on accounts held by customer 110 may appear improper. Similar operations may also be performed to the extent that transactions occurring on accounts held by other customers may appear improper. In such cases, computing system 381, computing system 361A, computing system 361B, and/or other systems may take actions similar to those described herein.

Modules illustrated in FIG. 3 (e.g., collection module 391, analysis module 395, alert module 397, transaction processing module 371, analysis module 373, modeling module 375, abstraction module 377, and others) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

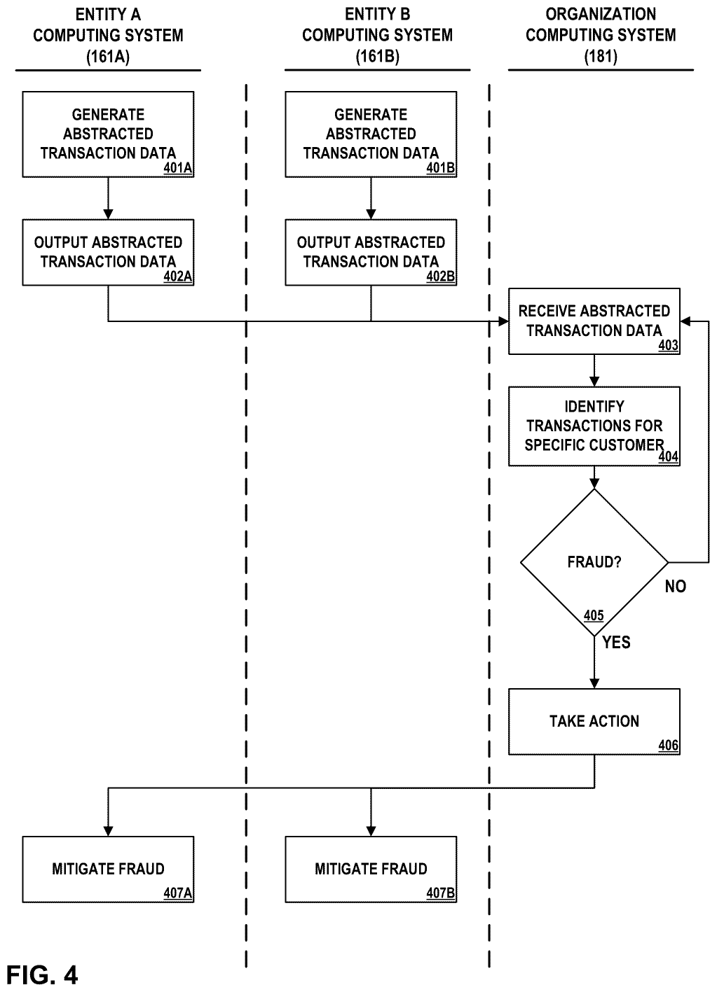

FIG. 4 is a flow diagram illustrating an example process for performing cross-entity fraud analysis in accordance with one or more aspects of the present disclosure. The process of FIG. 4 is illustrated from three different perspectives: operations performed by an example computing system 161A (left-hand column to the left of dashed line), operations performed by an example computing system 161B (middle column between dashed lines), and operations performed by an example computing system 181 (right-hand column to the right of dashed line). In the example of FIG. 4, the illustrated process may be performed by system 100 in the context illustrated in FIG. 1A. In other examples, different operations may be performed, or operations described in FIG. 4 as being performed by a particular component, module, system, and/or device may be performed by one or more other components, modules, systems, and/or devices. Further, in other examples, operations described in connection with FIG. 4 may be performed in a difference sequence, merged, omitted, or may encompass additional operations not specifically illustrated or described even where such operations are shown performed by more than one component, module, system, and/or device.

In the process illustrated in FIG. 4, and in accordance with one or more aspects of the present disclosure, computing system 161A may generate abstracted transaction data (401A). For example, computing system 161A of FIG. 1A may receive a series of transaction data 111A associated with customer 110, a series of transaction data 121A associated with customer 120, and a series of transaction data 131A associated with customer 130. Computing system 161A processes transaction data 111A to produce abstracted transaction data 112A, thereby removing personally-identifiable and/or privacy-sensitive information. Abstracted transaction data 112A may also be structured to prevent internal business information associated with entity 160A (see FIG. 1A) from being revealed if abstracted transaction data 112A and/or aspects of abstracted transaction data 112A are shared with other entities 160.

Similarly, computing system 161B may generate abstracted transaction data (401B). For example, computing system 161B may receive instances of transaction data 141B and transaction data 111B. Computing system 161B transform instances of transaction data 141B 111B data into instances of abstracted transaction data 142B and 112B, respectively. Such a transformation may be similar to that performed by computing system 161A, described above.

Computing system 161A may output abstracted data to computing system 181 (402A), and computing system 161B may output abstracted data to computing system 181 (402B). For example, computing system 161A causes abstracted transaction data 112A, abstracted transaction data 122A, and abstracted transaction data 132A to be output over a network. Similarly, computing system 161B causes abstracted transaction data 142B and abstracted transaction data 112B to be output over a network.

Computing system 181 may receive abstracted transaction data (403). For example, computing system 181 receives, over the network, abstracted transaction data 112A, 122A, 132A, 142B, and 112B. In some examples, computing system 181 analyzes the data, as described herein. In other examples, computing system 181 stores the data for later analysis; in such an example, computing system 181 may store such data only temporarily, but then later discards the data to avoid privacy implications of retaining a history of transaction data associated with each of customers.

Computing system 181 may identify transactions associated with a specific account holder (404). For example, computing system 181 evaluates abstracted transaction data 112A and abstracted transaction data 112B and determines that both abstracted transaction data 112A and abstracted transaction data 112B correspond to transaction data for the same person (i.e., customer 110). To make such a determination, computing system 181 may determine that both abstracted transaction data 112A and abstracted transaction data 112B include a reference to a code (e.g., a “federated ID”) that can be used to correlate data received from any of a number of different entities 160 with a specific person. Such a code may merely enable data to be correlated, however, without specifically identifying customer 110.

Computing system 181 may determine whether fraud is or may be occurring on accounts held by the specific account holder (405). For example, computing system 181 may analyze abstracted transaction data 112A and 112B to determine whether such information has any markers or indicia of a fraudulent, illegitimate, erroneous, or otherwise problematic transactions. In some cases, such indicia may include transaction velocity, transaction repletion, transaction type repetition, device type used to perform the transactions, and/or the locations at which transactions were performed.

If no fraud is detected, computing system 181 may continue monitoring and analyzing transactions received from computing system 161A and computing system 161B (NO path from 405). Even if fraud is not detected, computing system 181 may, as described elsewhere herein, output (e.g., on a subscription basis) abstracted transaction data to each of computing systems 161A and 161B. Computing system 181 may also output modeling information or other types of information to enable each of computing systems 161A and 161B to enhance modeling each performs internally.

If fraud is detected (YES path from 405), computing system 181 may take action in response to detecting fraud (406). For example, computing system 181 may notify each of computing systems 161A and 161B that fraud is occurring. Upon receiving such a notification, each of computing systems 161A and 161B may mitigate fraud (407A and 407B). Such mitigation may take the form of limiting access to or functionality of affected accounts. Such mitigation may involve contacting customer 110.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., computing systems 161, analyst computing systems 168, computing systems 181, analyst computing systems 188, computing systems 361, computing systems 381, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
receiving, by an independent computing system and from a first computing system controlled by a first bank, a first set of transaction data associated with accounts at the first bank;
receiving, by the independent computing system and from a second computing system controlled by a second bank, a second set of transaction data associated with accounts at the second bank, wherein the first bank and the second bank are competitor financial institutions, and wherein the independent computing system is not controlled by the first bank and is not controlled by the second bank;
identifying, by the independent computing system, transaction data associated with an account holder having a first account at the first bank and a second account at the second bank, wherein the transaction data associated with the account holder includes information about transactions occurring on the first account and information about transactions occurring on the second account;
assessing, by the independent computing system and based on the information about transactions occurring on the first account and information about transactions occurring on the second account, whether fraud has occurred on at least one of the first account or the second account; and
performing, by the independent computing system and based on the assessment of whether fraud has occurred, an action, wherein the action includes automatically outputting, over a network, a signal to the first computing system and the second computing system, wherein the signal includes cross-entity information comprising fraud assessment information derived from both the transactions occurring on the first account and the transactions occurring on the second account, wherein the independent computing system outputs the signal to the first computing system to thereby cause the first computing system to deny a first transaction for the first account and cease processing information associated with the first account, and wherein the independent computing system outputs the signal to the second computing system to thereby cause the second computing system to deny a second transaction for the second account and cease processing information associated with the second account.

2. The method of claim 1, wherein receiving the first set of transaction data includes:
receiving abstracted transaction data that has been processed to obscure identities of account holders and details of underlying transactions.

3. The method of claim 2, wherein receiving the abstracted transaction data includes:
receiving periodic abstracted transaction data that includes transactions grouped by a timeframe, and wherein each group of transactions includes information about a type of account associated with the grouped transactions, information summarizing sizes within the grouped transactions, and information summarizing quantities of the grouped transactions.

4. The method of claim 2, wherein receiving the abstracted transaction data includes:
receiving non-periodic abstracted transaction data that includes information about velocity attributes associated with the first set of transaction data.

5. The method of claim 2, wherein receiving the abstracted transaction data includes:
receiving modeling data generated by a computing system controlled by the first bank, wherein the modeling data represents a fraud analysis based on individual transactions underlying the abstracted transaction data.

6. The method of claim 1, wherein assessing whether fraud has occurred includes:
generating a model trained to identify unusual transactions for the account holder; and
determining, based on application of the model to the transaction data associated with the account holder, that fraud has occurred.

7. The method of claim 1, wherein assessing whether fraud has occurred includes determining that fraud has occurred, and wherein performing an action includes at least one of:
performing fraud mitigation; and
outputting an alert to each of the first computing system and the second computing system.

8. The method of claim 1, further comprising:
outputting, by the independent computing system and to the first computing system, information derived from the second set of transaction data associated with accounts at the second bank; and
outputting, by the independent computing system and to the second computing system, information derived from the first set of transaction data associated with accounts at the first bank.

9. The method of claim 8,
wherein outputting information derived from the second set of transaction data includes outputting information derived from the second set of transaction data at a first frequency; and
wherein outputting information derived from the first set of transaction data includes outputting information derived from the first set of transaction data at a second frequency.

10. The method of claim 9,
wherein the first frequency is based on a rate at which the independent computing system receives the first set of transaction data from the first computing system; and
wherein the second frequency is based on a rate at which the independent computing system receives the second set of transaction data from the second computing system.

11. The method of claim 10,
wherein the first frequency matches the rate at which the independent computing system receives the first set of transaction data from the first computing system.

12. A system comprising:
a first computing system, controlled by a first bank, configured to convert transaction data associated with a first account held by an account holder at the first bank into a first set of abstracted transaction data and output the first set of abstracted transaction data over a network;
a second computing system, controlled by a second bank, configured to convert transaction data associated with a second account held by the account holder at the second bank into a second set of abstracted transaction data and output the second set of abstracted transaction data over the network, wherein the first bank and the second bank are competitor financial institutions; and
an independent cross-entity computing system that is not controlled by the first bank, is not controlled by the second bank, and is configured to:
receive, from the first computing system, the first set of abstracted transaction data,
receive, from the second computing system, the second set of abstracted transaction data,
determine, based on the first set of abstracted transaction data and the second set of abstracted transaction data, that the first set of abstracted transaction data and the second set of abstracted transaction data correspond to transactions performed by the account holder,
assess, based on the first set of abstracted transaction data and the second set of abstracted transaction data, whether fraud has occurred on at least one of the first account or the second account, and
perform, based on the assessment of whether fraud has occurred, an action, wherein the action includes automatically outputting, over the network, a signal to the first computing system and the second computing system, wherein the signal includes cross-entity information comprising fraud assessment information derived from both the first set of abstracted transaction data associated with the first account and the second set of abstracted transaction data associated with the second account, wherein the independent cross-entity computing system outputs the signal to the first computing system to thereby cause the first computing system to deny a first transaction for the first account and cease processing information associated with the first account, and wherein the independent cross-entity computing system outputs the cross-entity information to the second computing system to thereby cause the second computing system to deny a second transaction for the second account and cease processing information associated with the second account.

13. The system of claim 12, wherein the independent cross-entity computing system is further configured to:
output, to the first computing system, information derived from the second set of abstracted transaction data; and
output, to the second computing system, information derived from the first set of abstracted transaction data.

14. The system of claim 13,
wherein the first computing system is further configured to assess, based on the information derived from the second set of abstracted transaction data, whether fraud has occurred on accounts associated with the account holder at the first bank; and
wherein the second computing system is further configured to assess, based on the information derived from the first set of abstracted transaction data, whether fraud has occurred on accounts associated with the account holder at the second bank.

15. The system of claim 14, wherein the first computing system is further configured to:
determine that fraud has occurred on the first account at the first bank; and
perform fraud mitigation, wherein the fraud mitigation includes contacting the account holder and limiting use of the first account.

16. The system of claim 12, wherein to receive the first set of abstracted transaction data, the independent cross-entity computing system is further configured to:
receive abstracted transaction data that has been processed to obscure information about the account holder and details of the transaction data associated with the first account.

17. The system of claim 16, wherein to receive the abstracted transaction data, the independent cross-entity computing system is further configured to:
receive periodic abstracted transaction data representing transactions grouped by a timeframe, and where each group includes information about a type of account associated with the group, information about a size of the group, and information about a quantity of transactions included within the group.

18. The system of claim 16, wherein to receive the abstracted transaction data, the independent cross-entity computing system is further configured to:
receive non-periodic abstracted transaction data that includes velocity information about the transaction data associated with the first account.

19. The system of claim 16, wherein to receive the abstracted transaction data, the independent cross-entity computing system is further configured to:
receive modeling data generated by the first computing system, wherein the modeling data includes information about a fraud analysis performed by the first computing system based on the transaction data associated with the first account.

20. An independent computing system having a storage media and processing circuitry, wherein the processing circuitry has access to the storage media and is configured to:
receive, from a first computing system controlled by a first bank, a first set of transaction data associated with accounts at the first bank;
receive, from a second computing system controlled by a second bank, a second set of transaction data associated with accounts at the second bank, wherein the first bank and the second bank are competitor financial institutions, and wherein the independent computing system is not controlled by the first bank and is not controlled by the second bank;
identify transaction data associated with an account holder having a first account at the first bank and a second account at the second bank, wherein the transaction data associated with the account holder includes information about transactions occurring on the first account and information about transactions occurring on the second account;
assess, based on the information about transactions occurring on the first account and information about transactions occurring on the second account, whether fraud has occurred on at least one of the first account or the second account; and
perform, based on the assessment of whether fraud has occurred, an action, wherein the action includes automatically outputting, over a network, a signal to the first computing system and the second computing system, wherein the signal includes cross-entity information comprising fraud assessment information derived from both the transactions occurring on the first account and the transactions occurring on the second account, wherein the independent computing system outputs the signal to the first computing system to thereby cause the first computing system to deny a first transaction for the first account and cease processing information associated with the first account, and wherein the computing system outputs the cross-entity information to the second computing system to thereby cause the second computing system to deny a second transaction for the second account and cease processing information associated with the second account.
